(19) United States
(12) Patent Application Publication
(10) Pub. No.: US 2017/0347835 A1
(43) Pub. Date: Dec. 7, 2017

(54) DOUBLE HINGE DOUBLE LEVEL CAMPING GRILL

(71) Applicant: Michael Stein, Toronto (CA)

(72) Inventor: Michael Stein, Toronto (CA)

(21) Appl. No.: 15/609,607

(22) Filed: May 31, 2017

Related U.S. Application Data
(60) Provisional application No. 62/345,151, filed on Jun. 3, 2016.

(51) Int. Cl. A47J 37/07; A47J 33/00

(52) U.S. Cl. CPC A47J 37/07; A47J 33/00

(57) ABSTRACT

The Double Hinge Double Level Camping Grill is designed for use with a two level camp tire enclosure, the grill comprising a first grill member and a second grill member pivotally coupled to each other via a pair of elongated members, each elongated member having opposite first and second ends, the first end of each elongated member being pivotally connected to the first grill member and the second end of each elongated member being pivotally connected to the second grill member wherein each pivotal connection of the elongated member is a 360 degree pivotal connection. When grilling, the functions when placed upon a two level camp fire include flipping up the bottom level to add wood, provide a hot bottom level and a top warm level providing twice the grill space. Post grilling, the members can be detached for cleaning and folded up for storage.

### BACKGROUND OF THE INVENTION

The present invention relates to grills for use with double level camping fire pit enclosures. Camp fire pit enclosures commonly used in various parks consist of an annular enclosure having side walls and an open top. The walls of the annular enclosure extend upwardly with the front half of the enclosure and the back half of the enclosure being of different heights such that the back half of the enclosure is taller than the front half of the enclosure leaving a two level top. While this type of fire pit enclosure is popular, it requires a user to bring two separate grills in order to utilize the entire potential cooking surface of the top of the enclosure. It is inconvenient to use two separate grills, particularly since the grills are not particularly stable when placed on the top of the fire pit enclosure. The present invention overcomes this problem with this sort of fire pit enclosure by providing a grill which actually uses the features of the enclosure to greater effect.

### DESCRIPTION OF THE DRAWINGS

FIG. 1 is a top view of a double hinged camping grill made in accordance with the present invention showing the double hinged grill in its fully extended position.

FIG. 2 is a top view of the double hinged camping grill shown in FIG. 1 showing the grill in its fully folded position.

FIG. 3 is a side view of the double hinged camping grill shown in FIG. 1 showing the grill in its articulated position.

FIG. 4 is a perspective view of the double hinged camping grill positioned on a two level fire pit enclosure.

FIG. 5 is a top view of an alternate embodiment of a double hinged camping grill made in accordance with the present invention.

### DETAILED DESCRIPTION OF THE INVENTION

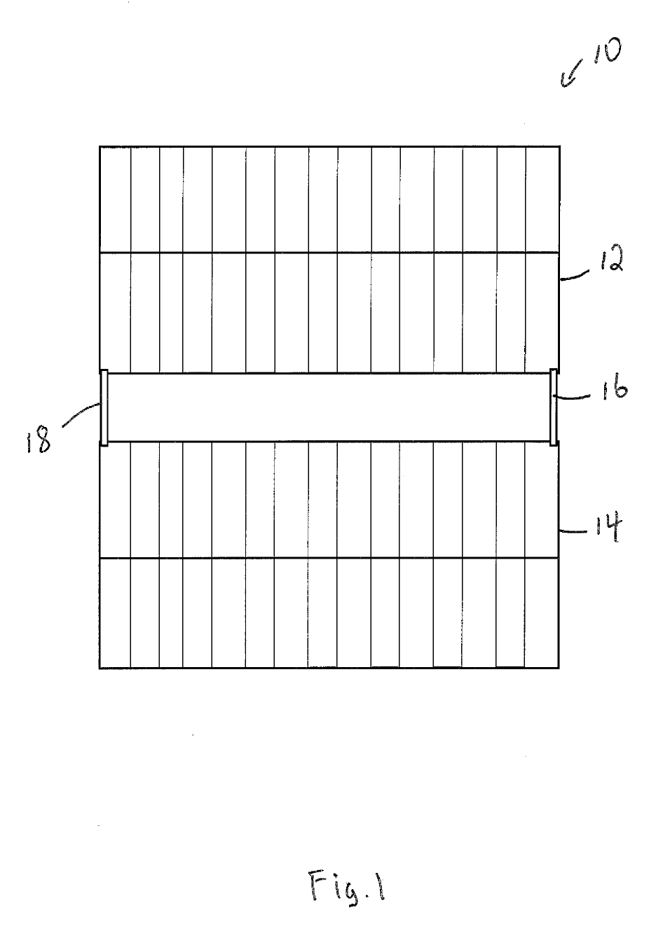

Referring firstly to FIG. 1, a camping grill made in accordance with the present invention is shown generally as item 10 and includes a first grill member 12 and a second grill member 14 coupled together by means of articulating hinges 16 and 18. Articulating hinges 16 and 18 consist of elongated members having opposite first and second ends, with the first end of each elongated member pivotally connected to grill member 12 and the second end of each elongated member pivotally connected to grill member 14.

Each of the elongated members are preferably made to be releasably coupled to either of the grill members, permitting the entire grill to be disassembled for cleaning, storage or where each grill member is to be used separately. Preferably, each elongated member is about 4 inches long and consists of a threaded rod having opposite ends, with each end of the rod coupled to a grill member by means of a threaded connector element which is in turn welded to the grill member. Each grill member preferably consists of a grid made of 3/16 inch steel rods, although other sizes may be used depending on the required stiffness and strength of the grill. The spacing between the steel rods is a function of the desired need, with 0.7 inches being typical for most applications. The dimensions of the grill members are also tailored to the dimensions of the fire enclosure used, but will typically be in the range of 25 inches in length to 13 inches in width. Preferably the grill members, the elongated members and the threaded connector elements are all made of a corrosion resistant alloy.

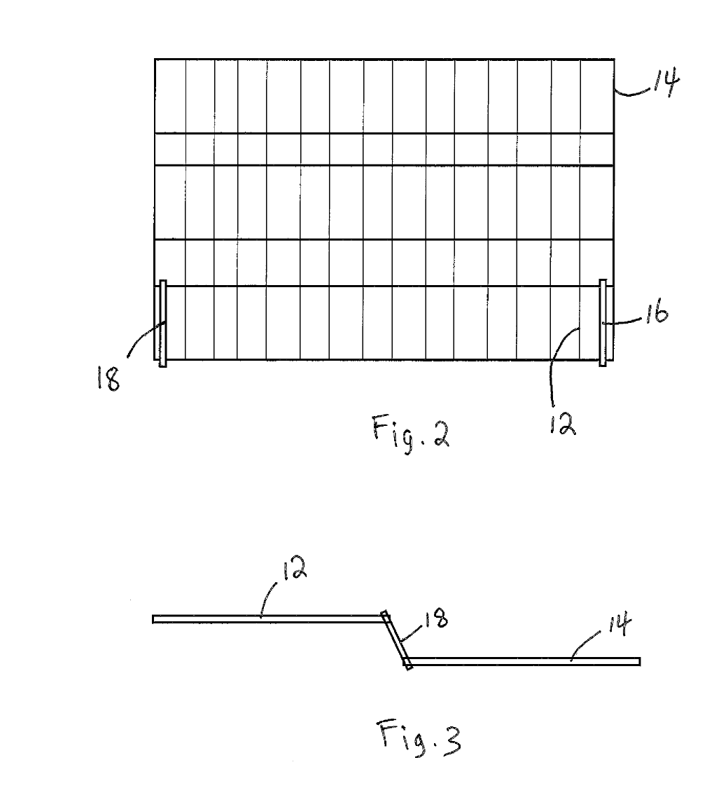

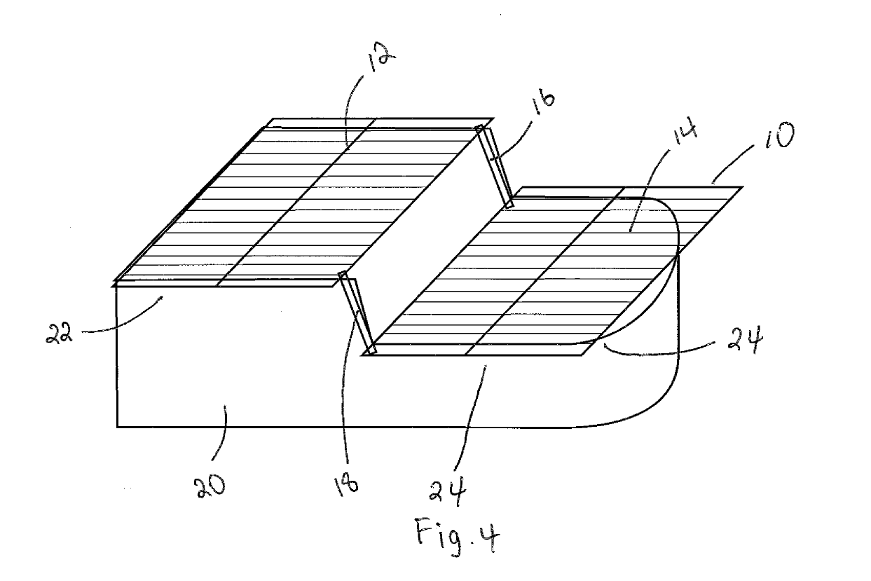

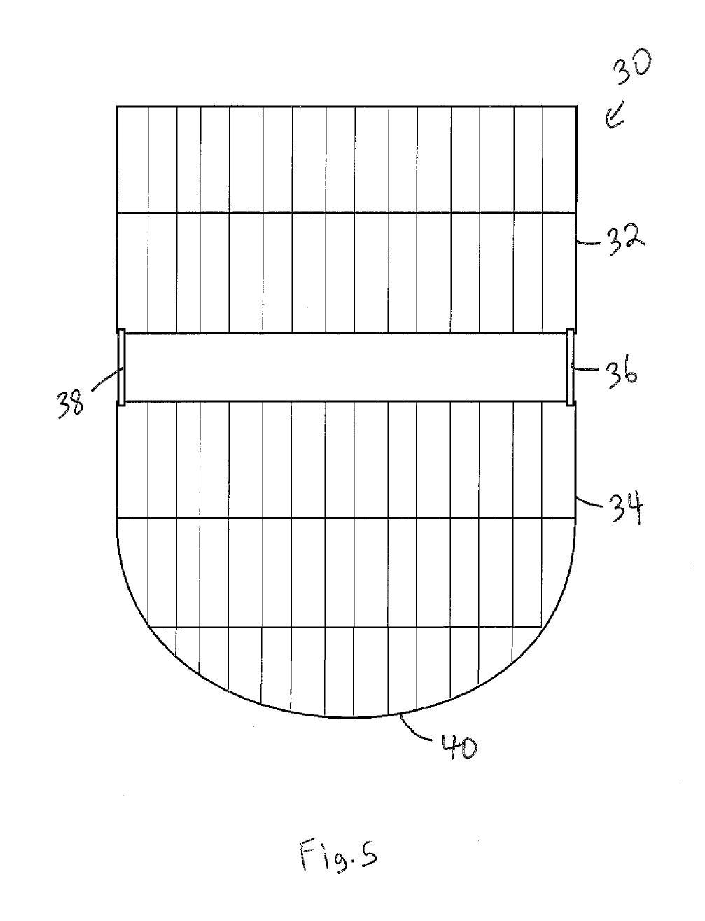

The pivotal connection of each elongated member to each of grill members 12 and 14 is a 360° connection, allowing the grill members to move pivotally with respect to each other in a plurality of different orientations. For example, as shown in FIG. 2, one grill member may be folded over the other to permit the entire grill to be folded into a more compact configuration. Alternatively, the two grill members can be articulated into a parallel articulated position as shown in FIG. 3 wherein one grill member is positioned above the other grill member. As best seen in FIG. 4, this articulated orientation of the grill is useful for placing grill 10 on top of an annular fire pit enclosure 20 with grill member 12 on top of rear portion 22 and grill member 14 on top of front portion 24. With the grill in this orientation on top of enclosure 20, the user can cook over the entire surface of the enclosure. Furthermore, since the grill members are connected to each other, the grill is more secure. Also, one grill member can be pivoted upwardly to add fuel to the fire contained within enclosure 20 without disturbing the other grill member. This allows greater flexibility allowing the user to replenish the fuel of the fire without having to remove pots or pans resting on grill. Furthermore, since grill member 14 is lower than grill member 12, grill member 14 can act as the “hot” grill since it is closer to the fire, while grill member 12 can act as the “simmer” or “warm” grill as it is further away from the fire.

FIG. 5 shows an alternate embodiment of the present invention which is identical to the embodiment shown in FIG. 1, differing only in the shape of one of the grill members. In the case of this embodiment of the grill, shown generally as item 30, grill member 32 is rectangular, while grill member 34 has a curved or semi-circular shape in order to better conform to the shape of the fire pit enclosure. Grill member 34 has a curved side 40 which is dimensioned to fit move closely to the front curvature of the fire pit enclosure. Elongated members 36 and 38 are each pivotally connected to both grill members 32 and 34 as in the previous embodiment. This embodiment of the grill functions in exactly the same manner as the previously discussed embodiment.

Regardless of the embodiment used, when placed on the fire enclose, the grill can be placed into two stable orientations. The first orientation is as shown in FIG. 3 and FIG. 4, where the two grill members are placed parallel to each other with one of the grill members positioned above the other grill member. Alternatively, the lower grill member can be pivoted upwards so that it rests substantially perpendicular to the upper grill member, thereby allowing the user free access to the interior of the fire enclosure, thereby permitting the addition of fuel to the fire or to manipulate the burning wood in the fire pit. The elongated members attaching the two grill members are preferably configured to ensure that the lowermost grill member can lean back slightly to rest against the uppermost grill member so as to hold the lowermost grill member in an elevated position. As mentioned previously, when the grill is off the fire enclosure, the grill may be folded with one grill member folded over top of the other grill member.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims

Therefore, what is claimed is:

1. A grill for use with a two level camp fire enclosure, the grill comprising a first grill member and a second grill member pivotally coupled to each other via a pair of elongated members, each elongated member having opposite first and second ends, the first end of each elongated member being pivotally connected to the first grill member and the second end of each elongated member being pivotally connected to the second grill member, wherein each pivotal connection of the elongated member is a 360° pivotal connection.
